(19) United States
(12) Patent Application Publication
(10) Pub. No.: US 2011/0272345 A1
(43) Pub. Date: Nov. 10, 2011

(54) CRYSTALLINE POLYMER MICROPOROUS MEMBRANE, METHOD FOR PRODUCING THE SAME, AND FILTRATION FILTER

(75) Inventors: Hirohisa Hokazono, Kanagawa (JP); Kimiaki Miyamoto, Tokyo (JP)

(73) Assignee: FUJIFILM CORPORATION, Minato-ku, Tokyo (JP)

(21) Appl. No.: 13/144,994

(22) PCT Filed: Dec. 17, 2009
(86) PCT No.: PCT/JP2009/071510

§ 371 Date: Jul. 18, 2011

(30) Foreign Application Priority Data
Jan. 29, 2009 (JP) 2009-018832

(51) Int. Cl. B01D 63/00; B29C 51/42; B32B 3/26

(52) U.S. Cl. 210/500.21; 428/315.5; 264/291

(57) ABSTRACT

The present invention provides a method for producing a crystalline polymer microporous membrane, which includes asymmetrically heating a film composed of crystalline polymer and being fixed, by a heating unit at a temperature equal to or higher than the melting point of a burned product of the crystalline polymer, so that one surface of the film is heated while being in contact with the heating unit, so as to form a semi-burned film having a temperature gradient in a thickness direction of the film composed of crystalline polymer; and stretching the semi-burned film.

### TECHNICAL FIELD

The present invention relates to a crystalline polymer microporous membrane which has high filtration efficiency and is used for precision filtration of gases, liquids and the like, to a method for producing the crystalline polymer microporous membrane, and to a filtration filter.

### BACKGROUND ART

Microporous membranes have long since been known and widely utilized for filtration filters, etc., (see Non-Patent Literature 1). As such microporous membranes, there are, for example, a microporous membrane using cellulose ester as a material (see Patent Literature 1, etc.), a microporous membrane using aliphatic polyamide as a material (see Patent Literature 2, etc.), a microporous membrane using polyfluorocarbon as a material (see Patent Literature 3, etc.), a microporous membrane using polypropylene as a material (see Patent Literature 4), and the like.

These microporous membranes are used for filtration and sterilization of washing water for use in the electronics industries, water for medical use, water for pharmaceutical production processes and water for use in food. In recent years, the applications and the amount of usage of microporous membranes have increased, and microporous membranes have gotten a lot of attention because of their high reliability in trapping particles. Among these, microporous membranes made of crystalline polymers are superior in chemical resistance, and in particular, microporous membranes produced using polytetrafluoroethylene (PTEF) as a raw material are superior in both heat resistance and chemical resistance, and demands of them are rapidly growing.

Meanwhile, Patent Literature 5 proposes a production method of a porous PTFE membrane, including, in the production processes, a step of applying a compressive stress to a pre-molded PTFE in a direction perpendicular to the extruding and/or rolling direction of the pre-molded PTFE, so that a degree of variability of haze of the resulting porous PTFE membrane is 20% or lower. According to this proposal, it is possible to homogenize the microporous structure of the microporous PTFE membrane. However, the microporous PTFE membrane according to this proposal is undesirably unsatisfactory in the flow rate in filtration and the filtration life.

Meanwhile, Patent Literature 6 proposes a production method of a porous polytetrafluoroethylene product, including a step of uniaxially stretching a tape at a temperature below the crystalline melting point of a polytetrafluoroethylene component and increasing the temperature of the tape to a temperature above the crystalline melting point of the polytetrafluoroethylene component so that the stretched tape is stabilized in the amorphous form, and a step of stretching the tape in a direction perpendicular to the initially stretched direction at a temperature above the crystalline melting point of the polytetrafluoroethylene component. According to this proposal, it is possible to increase the flow rate in filtration, however, has a shortcoming in that the filtration flow capacity per unit area of the microporous membrane decreases (in other words, the filtration life is short).

Further, Patent Literature 7 proposes a production method of a crystalline polymer microporous membrane, which includes a semi-burning step, in which thermal energy is applied to a surface of an unburned film so that the film has a temperature gradient in the film thickness direction. According to this proposal, multistage filtration is enabled by asymmetrically structured micropores, thereby making it possible to extend the filtration life of the microporous membrane. This proposed method, however, causes thermal nonuniformity. As a result, variations in average pore size are observed in its in-plane distribution of the resulting microporous membrane. When the microporous membrane is used in a small area (0.04 m² or smaller), it causes little trouble, but when used in a large area (larger than 0.04 m²), it may cause leakage of particles.

Accordingly, further improvement and development are highly desired to provide a crystalline polymer microporous membrane which has a homogenous in-plane distribution of average pore size, which is capable of efficiently trapping particles and achieving high-flow rate without causing clogging, and can be efficiently used even in a large area (large size equipment), and which has long filtration life, and a method for producing a crystalline polymer microporous membrane which makes it possible to efficiently produce the crystalline polymer microporous membrane.

### CITATION LIST

### Patent Literature

[PTL 1] U.S. Pat. No. 1,421,341

[PTL 2] U.S. Pat. No. 2,783,894

[PTL 3] U.S. Pat. No. 4,196,070

[PTL 4] German Patent No. 3,003,400

[PTL 5] Japanese Patent Application Laid-Open (JP-A) No. 2002-172316

[PTL 6] Japanese Patent Application Publication (JP-B) No. 11-515036

[PTL 7] Japanese Patent Application Laid-Open (JP-A) No. 2007-332342

### Non Patent Literature

[NPL 1] “Synthetic Polymer Membrane” written by R. Kesting, published by McGrawHill

### SUMMARY OF INVENTION

### Technical Problem

An object of the present invention is to solve the above-mentioned conventional problems and to achieve the following object. That is, an object of the present invention is to provide a crystalline polymer microporous membrane which has a homogenous in-plane distribution of average pore size, which is capable of efficiently trapping particles and achieving high-flow rate without causing clogging, and can be efficiently used even in a large area, and which has long filtration life, and to provide a method for producing a crystalline polymer microporous membrane which makes it possible to efficiently produce the crystalline polymer microporous membrane, and a filtration filter using the crystalline polymer microporous membrane.

### Solution to Problem

Means for solvent the foregoing problems are as follows:

<1> A method for producing a crystalline polymer microporous membrane, including:

asymmetrically heating a film composed of crystalline polymer and being fixed, by a heating unit at a temperature equal to or higher than the melting point of a burned product of the crystalline polymer, so that one surface of the film is heated while being in contact with the heating unit, so as to form a semi-burned film having a temperature gradient in a thickness direction of the film composed of crystalline polymer; and

stretching the semi-burned film.

In the method for producing a crystalline polymer microporous membrane according to <1>, in the asymmetrically heating step, the film of crystalline polymer is heated, and a semi-burned film having a temperature gradient in a thickness direction of the film is formed. On that occasion, since a film of the crystalline polymer is heated while being fixed and semi-burned, the film is heated and semi-burned without causing heating nonuniformity in its surface, and in the stretching step, the burned film is stretched. As a result, a crystalline polymer microporous membrane having a homogenous in-plane distribution of average pore diameter is obtained.

<2> The method according to <1>, wherein the entire surface of one surface of the film composed of crystalline polymer is fixed.

<3> The method according to one of <1> and <2>, wherein at least one surface of the film composed of crystalline polymer is fixed by a member, and the member is at least one of a pressing unit and a suction unit.

<4> The method according to <3>, wherein the pressing unit is any one of a belt, a roll, and a sheet.

<5> The method according to <4>, wherein a pressing pressure applied by the pressing unit is 0.01 MPa to 5 MPa.

<6> The method according to any one of <3> to <5>, wherein the suction unit is one of a belt and a roll each having a plurality of holes in a surface thereof and capable of sucking from the surface to the inside thereof.

<7> The method according to <6>, wherein the suction unit is one of a belt and a roll in each of which at least a surface thereof is heatable.

<8> The method according to any one of <1> to <7>, wherein the heating unit is one of a belt and a roll in each of which at least a surface thereof is heatable.

<9> The method according to any one of <1> to <8>, wherein the crystalline polymer is polytetrafluoroethylene.

<10> The method according to any one of <1> to <9>, wherein the stretching is stretching the semi-burned film in a uniaxial direction.

<11> The method according to any one of <1> to <10>, wherein the stretching is stretching the semi-burned film in a biaxial direction.

<12> The method according to any one of <1> to <11>, further including: subjecting the stretched film to a hydrophilication treatment.

<13> A crystalline polymer microporous membrane obtained by the method for producing a crystalline polymer microporous membrane according to any one of <1> to <12>, wherein an average pore size of one surface of the crystalline polymer microporous membrane is greater than the average pore size of the other surface thereof, and continuously varies from the one surface toward the other surface.

The crystalline polymer microporous membrane according to <13> is obtained by the method for producing a crystalline polymer microporous membrane according to any one of <1> to <12>. Since one surface of the crystalline polymer microporous membrane is greater than the average pore size of the other surface thereof, and continuously varies from the one surface toward the other surface, an in-plane distribution of average pore size of the membrane is homogenous, and even when used in a large area, the membrane is capable of efficiently trapping particles and achieving high-flow rate without causing clogging, and has long filtration life.

<14> The crystalline polymer microporous membrane according to <13>, wherein a value of P1/P2 is 4.5 or higher, provided that a film thickness of the crystalline polymer microporous membrane is represented by X, an average pore size of a portion with a thickness of X/10 in a depth direction from a non-heated surface of the crystalline polymer microporous membrane is represented by P1, and an average pore size of a portion with a thickness of 9X/10 in the depth direction from the non-heated surface is represented by P2.

<15> The crystalline polymer microporous membrane according to one of <13> and <14>, wherein an in-plane variation of the average pore size is produced at a coefficient of variation of 20% or lower.

<16> The crystalline polymer microporous membrane according to any one of <13> to <15>, wherein the area of the crystalline polymer microporous membrane is greater than 0.04 m².

<17> A filtration filter, wherein the filtration filter is obtained using the crystalline polymer microporous membrane according to any one of <13> to <16>.

Since the filtration filter according to <17> is produced using the crystalline polymer microporous membrane according to any one of <13> to <16>, it can trap particles without causing leakage thereof even when used in a large area, and can efficiently trap microparticles. Also, the filtration filter has a large specific surface area, it has a great effect of removing microparticles by suction or adhesion before the microparticles reach a portion having a smallest pore size, and the filtration life thereof can be significantly extended.

<18> The filtration filter according to <17>, wherein the filtration filter is processed so as to have a pleated shape.

<19> The filtration filter according to one of <17> and <18>, wherein a surface of the crystalline polymer microporous membrane having an average pore size greater than the average pore size of the other surface is used as a filtration surface of the filtration filter.

### Advantageous Effects of Invention

According to the present invention, it is possible to solve the above-mentioned conventional problems, to achieve the object described above, and to provide a crystalline polymer microporous membrane which has a homogenous in-plane distribution of average pore size, which is capable of efficiently trapping particles and achieving high-flow rate without causing clogging, and can be efficiently used even in a large area, and which has long filtration life, and to provide a method for producing a crystalline polymer microporous membrane which makes it possible to efficiently produce the crystalline polymer microporous membrane, and a filtration filter using the crystalline polymer microporous membrane.

### BRIEF DESCRIPTION OF DRAWINGS

FIG. 1 is a view illustrating the structure of an ordinary pleated filter element before mounted in a housing.

FIG. 2 is a view illustrating the structure of an ordinary filter element before mounted in a housing of a capsule-type filter cartridge.

FIG. 3 is a view illustrating a structure of an ordinary capsule-type filter cartridge formed integrally with a housing.

FIG. 4 is a view illustrating a single⁻sided heater used in Example 1.

FIG. 5 is a view illustrating a single-sided heater used in Example 2.

FIG. 6 is a view illustrating a single-sided heater used in Example 3.

FIG. 7 is a view illustrating a single-sided heater used in Example 4.

FIG. 8 is a view illustrating a single-sided heater used in Example 5.

FIG. 9 is a view illustrating a single⁻sided heater used in Example 6.

### DESCRIPTION OF EMBODIMENTS

### (Crystalline Polymer Microporous Membrane and Method for Producing Crystalline Polymer Microporous Membrane)

A method for producing a crystalline polymer microporous membrane according to the present invention includes at least an asymmetrically heating step and a stretching step, and if necessary, includes other steps such as a crystalline polymer film producing step and a hydrophilicating step.

The crystalline polymer microporous membrane of the present invention is produced by the method for producing a crystalline polymer microporous membrane.

Hereinafter, the crystalline polymer microporous membrane of the present invention will be described in detail through the description of the method for producing a crystalline polymer microporous membrane of the present invention.

Note that in the following description, a surface of a film provided with a larger average pore size is described as “non-heated surface”, and a surface of a film provided with a smaller average pore size is described as “heated surface”. They are merely so named for convenience and easy identification in this specification. Accordingly, after either surface of an unburned crystalline polymer film is heated in a semi-burned state, the semi-burned surface may be called “heated surface”.

### <Crystalline Polymer Film Producing Step>

The crystalline polymer film forming step is a step of forming a film composed of crystalline polymer (otherwise, may be referred to as “crystalline polymer film”).

### —Crystalline Polymer—

In the present invention, the term “crystalline polymer” means a polymer having a molecular structure in which crystalline regions containing regularly-aligned long-chain molecules are mixed with amorphous regions having not regularly aligned long-chain molecules. Such a polymer exhibits crystallinity through a physical treatment. For example, a polyethylene films is stretched by an external force, a phenomenon is observed in which the initially transparent film gets whitish. This phenomenon is derived from the expression of crystallinity which is obtained when molecular alignment in the polymer is aligned in one direction by the external force.

The crystalline polymer is not particularly limited and may be suitably selected in accordance with the intended use. For example, there may be exemplified polyalkylenes, polyesters, polyamides, polyethers, and liquid crystalline polymers. Specific examples thereof include polyethylenes, polypropylenes, nylons, polyacetals, polybutylene terephthalates, polyethylene terephthalates, syndiotactic polystyrenes, polyphenylene sulfides, polyether-etherketones, wholly aromatic polyamides, wholly aromatic polyesters, fluororesins, and polyethernitriles.

Among these, preferred are polyalkylenes (e.g. polyethylenes and polypropylenes); more preferred are fluoropolyalkylenes in which a hydrogen atom of the alkylene group in polyalkylene is partially or wholly substituted with a fluorine atom; and especially preferred are polytetrafluoroethylenes (PTFE).

The polyethylenes change their densities by the degree of branching, and classified into two types, i.e., low density polyethylenes (LDPE) having low degree of crystallinity, and high density polyethylenes (HDPE) having high degree of crystallinity. Both of them may be used. Among these, polyethylene or a crystalline polymer whose hydrogen atom is substituted with a fluorine atom is used, with particular preference being given to polytetrafluoroethylene (PTFE).

The crystalline polymer preferably has a number average molecular weight of 500 to 50,000,000, more preferably 1,000 to 10,000,000.

As the crystalline polymer, polyethylene is preferable. For example, polytetrafluoroethylene can be used. As the polytetrafluoroethylene, typically, polytetrafluoroethylene produced by emulsion polymerization can be used. Preferably, a polytetrafluoroethylene in the form of a micropowder, which is produced by coagulating an aqueous dispersion obtained by emulsion polymerization, is used.

The polytetrafluoroethylene preferably has a number average molecular weight of 2,500,000 to 10,000,000, more preferably 3,000,000 to 8,000,000.

The material of the polytetrafluoroethylene is not particularly limited and may be selected from among commercially available polytetramethylene materials. For example, preferred examples include “POLYFLON FINE POWDER F104U” produced by Daikin Industries Ltd.

The crystalline polymer preferably has a glass transition temperature of 40° C. to 400° C., more preferably 50° C. to 350° C. The crystalline polymer preferably has a mass average molecular weight of 1,000 to 100,000,000. The crystalline polymer preferably has a number average molecular weight of 500 to 50,000,000, more preferably 1,000 to 10,000,000.

The crystalline polymer film is preferably produced according to the following method. Firstly, the polytetrafluoroethylene material is mixed with an extrusion-aiding agent to prepare a mixture, and the mixture is paste-extruded and rolled. As the extrusion-aiding agent, a liquid lubricant is preferably used. Specifically, solvent naptha, and white oil are exemplified. As the extrusion-aiding agent, commercially marketed hydrocarbon oils, such as “ISOPER” available from Esso Oil Co., Ltd., may be used. The additive amount of the extrusion-aiding agent is preferably 20 parts by mass to 30 parts by mass relative to 100 parts by mass of the crystalline polymer.

The paste-extruding is preferably performed at a temperature of 50° C. to 80° C. The extruded form of the mixture is not particularly limited and may be suitably selected in accordance with the intended use. Typically, the mixture is preferably formed in a rod shape. Next, the extrudate is rolled to be formed into a film. This can be achieved by calendering the mixture by a calender roll at a speed of 50 m/min. The roll temperature is typically set to 50° C. to 70° C. Afterward, it is preferred that the extrusion-aiding agent be removed by heating to form an unburned crystalline polymer film. The heating temperature at this time can be suitably determined according to the type of crystalline polymer to be used. It is however preferably 40° C. to 400° C., more preferably 60° C. to 350° C. For example, when tetrafluoroethylene is used for the crystalline polymer, the heating temperature is preferably 150° C. to 280° C., more preferably 200° C. to 255° C. The heating can be performed by, for example, passing the film through a hot air drying oven. The thickness of the unburned crystalline polymer film thus produced can be suitably controlled according to the thickness of a crystalline polymer microporous membrane intended to be finally produced. When the unburned crystalline polymer film is stretched in a subsequent step, it is necessary to control the thickness of the unburned crystalline polymer in consideration of reduction in thickness associated with the stretching.

Note that when producing an unburned crystalline polymer film, it is possible to appropriately proceed with the necessary processes in line with the description in “Polyflon Handbook” (Daikin Industries Ltd., edited in 1983).

### —Asymmetrically Heating Step—

The asymmetrically heating step is a step of heating one surface of a securely retained (fixed) film composed of crystalline polymer at a temperature higher than the melting point of a burned product of the crystalline polymer (otherwise, referred to as “burned crystalline polymer film) by a heating unit in a state of being in contact with the heating unit to form a semi-burned film having a temperature gradient along the thickness direction of the film. With this, the film can be heated without any heating nonuniformity, the resulting crystalline polymer microporous membrane has a homogenous in-plane distribution of average pore size, and the heating temperature can be controlled in an asymmetrical manner along the thickness direction of the crystalline polymer microporous membrane.

Here, the terms “semi-burning” and “semi-burned” mean that the crystalline polymer is heated at a temperature equal to or higher than the melting point of a burned product of the crystalline polymer (the burned crystalline polymer film) and equal to or lower than the melting point of an unburned product of the crystalline polymer (the unburned crystalline polymer film) plus 15° C.

Also, in the present invention, the terms “unburned product of crystalline polymer” and “unburned crystalline polymer” mean the crystalline polymer that has not yet subjected to a burning (heating) treatment. The term “melting point of the crystalline polymer” means an endothermic peak temperature of the endothermic curve that appears when a melting point of the unburned product of the crystalline polymer is measured by a differential scanning calorimeter. The melting point of the burned product and the melting point of the unburned product vary depending on the type of crystalline polymer used and the average molecular weight thereof, however, they are preferably in the range of from 50° C. to 450° C., more preferably in the range of from 80° C. to 400° C.

These heating temperatures can be considered as follows. For example, when the crystalline polymer is polytetrafluoroethylene, the melting point of the burned product thereof is approximately 324° C. and the melting point of the unburned product thereof is approximately 345° C. Therefore, in order to obtain a semi-burned product of polytetrafluoroethylene, in the case of a polytetrafluoroethylene film, the heating temperature is preferably 327° C. to 360° C., more preferably 335° C. to 350° C. For example, if the polytetrafluoroethylene film is heated to 345° C., a semi-burned product thereof is in a state where components having a melting point of approximately 324° C. are mixed with components having a melting point of approximately 345° C.

The semi-burning is performed by heating one surface of a securely retained (fixed) film of crystalline polymer at a temperature higher than the melting point of the burned product of the crystalline polymer (the burned crystalline polymer film) by a heating unit in a state of being in contact with the heating unit.

Desirably, the entire surface of one surface of the film composed of crystalline polymer (otherwise, referred to as “the crystalline polymer film”) is securely retained or fixed. The method of fixing the one surface of the crystalline polymer film in place is not particularly limited and may be suitably selected in accordance with the intended use. However, preferably, at least one surface of the film is fixed with equipment. The equipment is not particularly limited particularly limited and may be suitably selected in accordance with the intended use. However, the equipment is preferably capable of at least one of pressing and sucking.

The fixed surface of the crystalline polymer film is not particularly limited and may be suitably selected according to the purpose. For example, when the after-mentioned pressing unit is used, the crystalline polymer film is pressed against the heating unit by the pressing unit, and both surfaces of the crystalline polymer film may be used as fixed surfaces. When the after-mentioned sucking unit is used, one surface of the crystalline polymer film may be fixed by the sucking unit. Both surfaces of the crystalline polymer film may be fixed using a pressing unit or a combination of a pressing unit with a heating unit.

### —Pressing Unit—

The pressing unit is not particularly limited and may be suitably selected in accordance with the intended use. It is however preferably a belt, a roll, and a sheet. More preferred are a belt and a sheet.

The belt is not particularly limited and may be suitably selected in accordance with the intended use. It is however preferably an endless belt.

The roll is not particularly limited and may be suitably selected in accordance with the intended use.

The sheet is not particularly limited and may be suitably selected in accordance with the intended use. It is however preferably a roll sheet.

Ordinarily, as the fixing of a sheet such as a film composed of crystalline polymer, a method is employed in which the sheet is attached to a heating unit such as a heating roll. However, when the ordinary method is employed in the present invention, undesirably, a film composed of crystalline polymer is easily stretched to have a porous structure if an excessive tension is applied thereto.

Meanwhile, the pressing unit used in the present invention is configured to press a film composed of crystalline polymer against the after-mentioned heating unit and to be rotated so as to convey the film composed of crystalline polymer in a fixed manner. As a result, the above-mentioned problem does not occur, and when a surface of the film composed of crystalline polymer being in contact with the after-mentioned heating unit is heated by the heating unit, it is possible to suppress deformation of the film composed of crystalline polymer and to prevent the occurrence of heating nonuniformity.

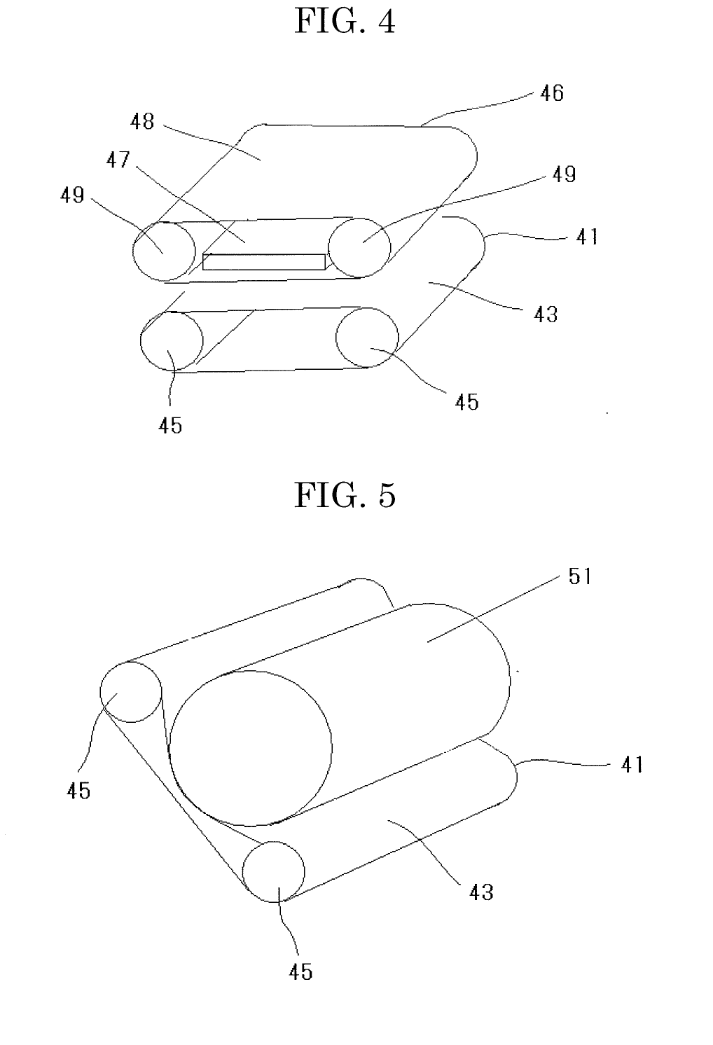

The structure of the endless belt is not particularly limited and may be suitably selected in accordance with the intended use. For example, a pressing belt unit 41 illustrated in FIGS. 4 and 5, etc. are exemplified. The pressing belt unit 41 includes an endless belt 43 and endless belt rolls 45 which are provided at both inner ends of the endless belt 43.

Materials of the endless belt and the endless belt rolls are not particularly limited and may be suitably selected in accordance with the intended use. However, a raw material is preferred which is resistant to a temperature of equal to or higher than the melting point of a burned product of the crystalline polymer and has sufficient strength to withstand the pressing pressure applied thereto. For example, metals are exemplified. Preferred examples thereof are SUS304H, and steels.

The roll sheet is not particularly limited and may be suitably selected in accordance with the intended use. It is however preferably a raw material that is resistant to a temperature of equal to or higher than the melting point of a burned product of the crystalline polymer and has sufficient strength to withstand the pressing pressure applied thereto. For example, heat-resistant resins are exemplified. Preferred examples of the heat-resistant resins include UPILEX 75S (produced by Ube Industries Ltd.).

The pressing pressure applied by the pressing unit is not particularly limited, as long as a film composed of crystalline polymer can be fixed to the heating unit, and may be suitably controlled according to the purpose. It is however preferably 0.01 MPa to 5 MPa, more preferably 0.1 MPa to 3 MPa, and particularly preferably 0.5 MPa to 1 MPa. When the pressing pressure is lower than 0.01 MPa, it may be impossible to prevent the film composed of crystalline polymer from deforming during heating. When it is higher than 5 MPa, the film composed of crystalline polymer may be rolled out.

The method of measuring the pressing pressure is not particularly limited and may be suitably selected in accordance with the intended use. For example, it can be measured using a pressure measuring film (e.g., PRESCALE, produced by Fujifilm Holdings Corporation).

The size of the endless belt is not particularly limited and may be suitably selected in accordance with the intended use. However, the circumferential length of the endless belt is preferably 400 mm to 3,000 mm, more preferably 500 mm to 2,000 mm, particularly preferably 600 mm to 1,500 mm. When the size (circumferential length) of the endless belt is smaller than 400 mm, heating nonuniformity may take place due to the small contact area between the film composed of crystalline polymer and the endless belt. When it is greater than 3,000 mm, the equipment becomes excessively large in size. In contrast, with the size of the endless belt being in the particularly preferred range, it is possible to prevent heating nonuniformity and to obtain a crystalline polymer microporous membrane having a homogenous in-plane distribution of average pore size.

The size of the endless belt rolls is not particularly limited and may be suitably selected according to the size of the belt.

The diameter of the rolls is not particularly limited and may be suitably selected according to the purpose. It is however preferably 50 mm to 700 mm, more preferably 100 mm 600 mm, particularly preferably 150 mm to 500 mm. When the diameter of the rolls is smaller than 50 mm, heating nonuniformity may take place due to the small contact area between the film composed of crystalline polymer and the endless belt. When it is greater than 700 mm, the equipment becomes excessively large in size. In contrast, with the size of the endless belt being in the particularly preferred range, it is possible to prevent heating nonuniformity and to obtain a crystalline polymer microporous membrane having a homogenous in-plane distribution of average pore size.

The size of the roll sheet is not particularly limited, as long as the crystalline polymer film can be fully covered therewith, and may be suitably selected in accordance with the intended use. The size of the roll sheet in a width direction of the roll sheet with respect to the width of the crystalline polymer film is preferably 100% to 200%, more preferably 105% to 150%, particularly preferably 110% to 130%. The total length of the roll sheet with respect to the total length of a roll of the crystalline polymer film is preferably 100% to 200%, more preferably 105% to 150%, particularly preferably 110% to 130%. When the size of the roll sheet is less than 100% with respect to the width of the crystalline polymer film and the total length of the roll of the crystalline polymer film, heating nonuniformity may take place due to the small contact area between the film composed of crystalline polymer and the roll sheet. When it is more than 200%, the equipment becomes excessively large in size. In contrast, with the size of the roll sheet being in the particularly preferred range, it is possible to prevent heating nonuniformity and to obtain a crystalline polymer microporous membrane having a homogenous in-plane distribution of average pore size.

### —Heating Unit—

The heating unit is not particularly limited and may be suitably selected in accordance with the intended use. However, preferred is a belt and a roll in each of which at least a surface thereof is heatable.

The belt which can be heated on at least a surface thereof is not particularly limited and may be suitably selected in accordance with the intended use. It is however preferably an endless belt heater.

The roll which can be heated on at least a surface thereof is not particularly limited and may be suitably selected in accordance with the intended use. It is however preferably a roll heater.

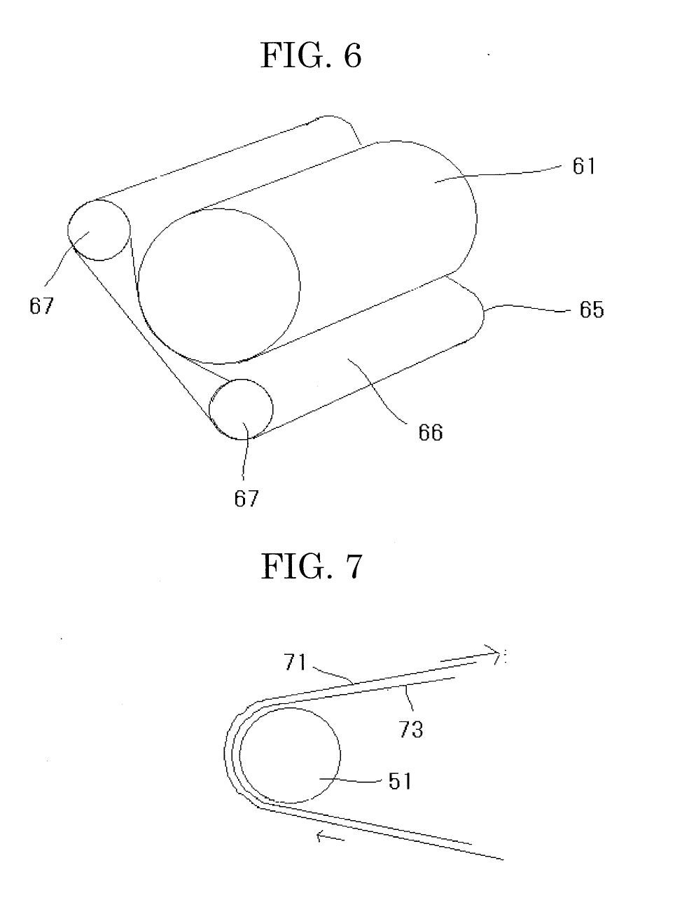

The structure of the endless belt heater is not particularly limited and may be suitably selected in accordance with the intended use. For example, an endless belt heater illustrated in FIGS. 4 and 6 is exemplified.

An endless belt heater 46 in FIG. 4 includes an endless belt 48, non-heating rolls 49 which are provided at both inner ends of the endless belt 48 and a heater 47 provided inside the endless belt 48. The endless belt 48 is heated by the heater 47, and can heat a film composed of crystalline polymer by its surface while conveying the film composed of crystalline polymer.

An endless belt heater 65 in FIG. 6 includes an endless belt 66 and heating rolls 67 which are provided at both inner ends of the endless belt 66. The endless belt 66 is heated by the heating rolls 67 and can heat a film composed of crystalline polymer by its surface while conveying the film composed of crystalline polymer.

The material and the size of the endless belt for use in the endless belt heater are not particularly limited and may be suitably selected in accordance with the intended use. The endless belt may be the same size and made of the same material as the pressing unit described above.

The size of the non-heating rolls for use in the endless belt heater is not particularly limited and may be suitably selected according to the size of the belt.

The heater for use in the endless belt heater is not particularly limited and may be suitably selected in accordance with the intended use. Examples thereof include a resistance heater, an infrared ray heater, a micro-wave heater, and an induction heater.

The heating rolls for use in the endless belt heater are not particularly limited and may be suitably selected in accordance with the intended use. It is however preferably induction heat generating rolls.

The induction heat generating roll has a roll shell which inductively generates heat by a coil placed inside the roll. Specifically, an alternating current is supplied to an electric induction coil, a magnetic flux is generated in the coil. By the action of the magnetic flux, an induction current is induced inside the roll shell (outer cylinder) placed so as to face the coil, and by the resistance heat, the induction heat generating roll generates heat (inductively generates heat) by itself. Unlike other indirect heating systems such as oil circulation systems, and hot water circulation systems, the induction heat generating roll itself directly generates heat, and thus it enables efficiently high-temperature thermal energy according to need.

In addition, the temperature of the roll surface can be kept uniformly with high accuracy in its width direction as well as in its circumferential direction by a heat pipe mechanism.

As the induction heat generating rolls, commercially available products can be used. Examples thereof include induction heat-generating metal rolls mounted in “induction heat-generating high-temperature high-speed calendering machines (set up in the company building of Yuri Roll Co., Ltd.)” manufactured by Yuri Roll Co., Ltd.

The size of the heating rolls for use in the endless belt heater is not particularly limited and may be suitably selected according to the size of the belt.

The roll heater is not particularly limited and may be suitably selected in accordance with the intended use. For example, a heating roll can be used.

The heating roll used as the roll heater is not particularly limited and may be suitably selected in accordance with the intended use. It is however preferably an induction heat-generating roll described above in the section of the belt heater.

A diameter of the heating roll used as the roll heater is not particularly limited and may be suitably selected in accordance with the intended use. It is however preferably 50 mm to 700 mm, more preferably 100 mm to 600 mm, particularly preferably 150 mm to 500 mm. When the diameter of the heating roll is smaller than 50 mm, heating nonuniformity may occur due to the small contact area between the crystalline polymer film and the heating roll. When it is greater than 700 mm, the equipment becomes excessively large in size. In contrast, with the diameter of the heating roll being in the particularly preferred range, it is possible to prevent heating nonuniformity and to obtain a crystalline polymer microporous membrane having a homogenous in-plane distribution of average pore size.

A combination of the pressing unit with the heating unit is not particularly limited and may be suitably selected in accordance with the intended use.

The heating unit may be used in contact with a surface of the crystalline polymer film which is fixed with or retained by the after-mentioned suction unit.

### —Suction Unit—

The suction unit is not particularly limited and may be suitably selected in accordance with the intended use. It is however preferably one of a belt and a roll each having a plurality of pores formed on its surface and capable of sucking an object from the surface in the inside thereof.

The belt having a plurality of pores formed on its surface and capable of sucking an object from the surface in the inside thereof is not particularly limited and may be suitably selected in accordance with the intended use. It is however preferably a suction belt.

The roll having a plurality of pores formed on its surface and capable of sucking an object from the surface in the inside thereof is not particularly limited and may be suitably selected in accordance with the intended use. It is however preferably a suction roll.

The suction belt and the suction roll are each configured to suck the crystalline polymer film and rotate so as to convey the crystalline polymer film while being securely retained on a surface thereof. As a result, it is possible to suppress deformation of the crystalline polymer film and to prevent the occurrence of heating nonuniformity when a surface of the crystalline polymer film to be contact with a heating unit is heated by the heating unit.

Also, the suction unit is preferably one of a belt and a roll in each of which at least a surface thereof is heatable.

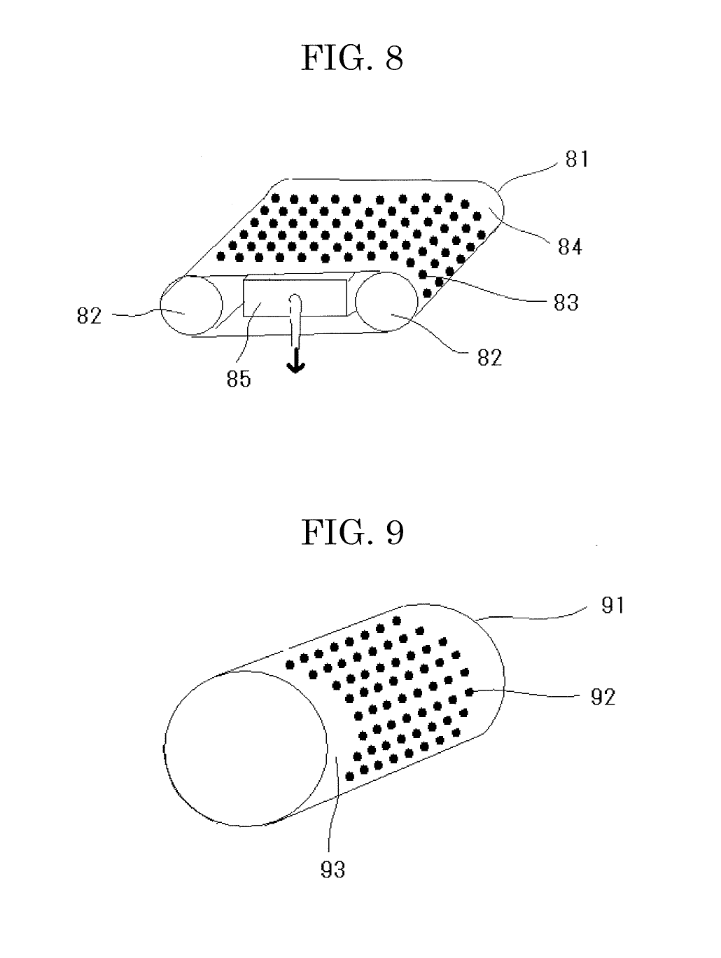

The structure of the suction belt is not particularly limited and may be suitably selected in accordance with the intended use. Examples thereof include a suction belt unit 81 illustrated in FIG. 8. The suction belt unit 81 includes heating rolls 82 which are provided at both inner ends thereof, an endless belt 84 having suction holes 83 on its surface, and a vacuum box 85 which is provided inside the endless belt 84. The inside of the endless belt 84 is subjected to suction, and a reduced pressure is established therein. The endless belt 84 can securely retain the crystalline polymer film at its surface while conveying the crystalline polymer film. Also, the endless belt 84 is heated by the heating rolls 82, and thereby capable of heating the crystalline polymer film by its surface while conveying the crystalline polymer film.

The structure of the suction roll is not particularly limited and may be suitably selected in accordance with the intended use. Examples thereof include a suction heating roll unit 91 illustrated in FIG. 9. The suction heating roll unit 91 includes a roll 93 having a vacuum-loadable hollow section at the inside thereof and suction holes 92 at its surface, and a vacuum device (not illustrated) connected to the roll 93. The inside of the roll 93 is subjected to suction, and a reduced pressure is established therein. The roll 93 can securely retain the crystalline polymer film at its surface while rotating around its own shaft.

The roll 93 may generate heat by itself so as to serve also as a heating unit or may be heated through a heater to serve also as a heating unit. The roll 93 can heat the crystalline polymer film at its surface while conveying the crystalline polymer film.

Materials of the suction belt and the suction roll are not particularly limited and may be suitably selected in accordance with the intended use. However, a raw material is preferred which is resistant to a temperature of equal to or higher than the melting point of a burned product of the crystalline polymer. For example, metals are exemplified. Preferred examples thereof include SUS304H.

The shape of a cross-section perpendicular to the axial direction of the suction belt and the suction roll is not particularly limited and may be suitably selected in accordance with the intended use. Examples of the shape include hexagonal shape, quadrangular shape, circular shape, oval shape, rectangular shape, meshed shape, and infinite form. Among these, a circular shape is preferable. The maximum diameter of suction holes of the suction belt and the suction roll is not particularly limited and may be suitably selected in accordance with the intended. It is however preferably 0.1 mm to 10 mm, more preferably 0.2 mm to 7 mm, particularly preferably 0.3 mm to 5 mm. When the maximum diameter of suction holes of the suction belt and the suction roll is greater than 10 mm, a pattern of the suction holes may be left in the crystalline polymer film.

The pitch between suction holes (average distance between center lines of adjacent suction holes) of the suction belt and the suction roll is not particularly limited and may be suitably selected in accordance with the intended use. It is however preferably 0.5 mm to 50 mm, more preferably 1 mm to 40 mm, particularly preferably 5 mm to 20 mm. When the pitch between the suction holes of the suction belt and the suction roll is shorter than 0.5 mm, the strength of the suction belt and the suction roll may become insufficient due to the excessively increased rate of hole area. When the pitch is greater than 50 mm, the suction force may become weak and air accumulation may easily take place.

The way of arraying suction holes of the suction belt and the suction roll is not particularly limited and may be suitably selected in accordance with the intended use.

The method of forming suction holes of the suction belt and the suction roll is not particularly limited and may be suitably selected in accordance with the intended use. For example, a method is exemplified in which suction holes are punched with a drill.

The rate of hole area of the suction belt or the suction roll is not particularly limited and may be suitably selected in accordance with the intended use. It is however preferably 0.01% to 50%, more preferably 0.05% to 20%, particularly preferably 0.1% to 10%. When the rate of hole area of the suction belt or the suction roll is lower than 0.01%, the suction force may become insufficient. When it is higher than 50%, the strength of the suction belt and the suction roll may become insufficient.

Note that the term “the rate of hole area of the suction belt or the suction roll” is an area occupied by holes (hole section), over the entire surface of the suction belt or the suction roll.

The suction force of the suction belt or the suction roll is not particularly limited and may be suitably selected in accordance with the intended use. A difference of atmospheric pressure from the internal pressure of the suction belt or the suction roll is preferably 0.5 KPa to 60 KPa, more preferably 1 KPa to 40 KPa, particularly preferably 3 KPa to 20 KPa. When the difference atmospheric pressure from the internal pressure of the suction belt or the suction roll is smaller than 0.5 KPa, it may be difficult to securely retain the crystalline polymer film on the surface of the suction belt or the suction roll. When the difference is greater than 60 KPa, suction pattern(s) may be left in the crystalline polymer film.

The surface of the suction belt or the suction roll is preferably processed so as not to leave suction pattern(s) in the crystalline polymer film. The process is not particularly limited and may be suitably selected in accordance with the intended use. For instance, the surface of the suction belt or the suction roll may be covered with a layer having suction holes smaller than the suction holes of the suction belt or the suction roll.

The size of the endless belt of the suction belt is not particularly limited and may be suitably selected in accordance with the intended use. However, the size of the endless belt is preferably 400 mm to 3,000 mm, more preferably 500 mm to 2,000 mm, particularly preferably 600 mm to 1,500 mm. When the circumferential length of the endless belt is shorter than 400 mm, heating nonuniformity may take place due to the small contact area between the crystalline polymer film and the endless belt. When it is longer than 3,000 mm, the equipment becomes excessively large in size. In contrast, with the size of the endless belt being in the particularly preferred range, it is possible to prevent heating nonuniformity and to obtain a crystalline polymer microporous membrane having a homogenous in-plane distribution of average pore size.

The size of the suction belt roll for use in the suction belt is not particularly limited and may be suitably selected according to the size of the suction belt.

The roll diameter of the suction belt roll is not particularly limited and may be suitably selected in accordance with the intended use. It is however preferably 50 mm to 700 mm, more preferably 100 mm to 600 mm, particularly preferably 150 mm to 500 mm. When the roll diameter is smaller than 50 mm, heating nonuniformity may take place due to the small contact area between the crystalline polymer film and the roll. When the roll diameter is greater than 700 mm, the equipment becomes excessively large in size. In contrast, with the roll diameter being in the particularly preferred range, it is possible to prevent heating nonuniformity and to obtain a crystalline polymer microporous membrane having a homogenous in-plane distribution of average pore size.

The method of heating the suction belt or the suction roll is not particularly limited and may be suitably selected in accordance with the intended use. Examples thereof include a method of heating the suction belt or suction roll from the inside or outside by a heating medium; a method of heating the suction belt or suction roll from the inside or outside by a heater; a method of heating the suction belt or suction roll from the outside by a unit for blowing hot air; and a method of allowing the suction belt or suction roll itself to generate heat by electromagnetic induction. Among these methods, preferred is a method of allowing the suction belt or suction roll itself to generate heat by electromagnetic induction. The heating medium for use in the method of heating the suction belt or suction roll from the inside or outside by a heating medium is not particularly limited and may be suitably selected in accordance with the intended use. For example, heating oil is exemplified.

The heater for use in the method of heating the suction belt or suction roll from the inside or outside by a heater is not particularly limited and may be suitably selected in accordance with the intended use.

The unit for blowing hot air for use in the method of heating the suction belt or suction roll from the outside by a unit for blowing hot air is not particularly limited and may be suitably selected in accordance with the intended use. For example, a hot-air blower, and a hot-air nozzle are exemplified.

The method of allowing the suction belt or suction roll itself to generate heat by electromagnetic induction is not particularly limited and may be suitably selected in accordance with the intended use. For example, the induction type heat generating roll described in the section of the belt heater is exemplified. The method of allowing the suction belt itself to generate heat also includes an aspect in which heating rolls provided at inner ends of an endless belt just as in the belt heater described above are used as induction heat generating rolls.

### —Heating Method—

As described above, by heating one surface of a film composed of crystalline polymer and being fixed at a temperature equal to or higher than the melting point of the crystalline polymer by a heating unit while being in contact with the heating unit, the heating temperature can be asymmetrically heated only in a thickness direction of the film, and the crystalline polymer microporous membrane of the present invention can be produced with ease.

The temperature gradient in a thickness direction of the film composed of crystalline polymer is not particularly limited and may be suitably selected in accordance with the intended use. However, a temperature difference between the heated surface and the non-heated surface is preferably 30° C. or more, more preferably 50° C. or more.

The temperature of the heating unit is not particularly limited and may be suitably selected according to the temperature used when producing the semi-burned product.

The method of controlling the heating temperature of the film composed of crystalline polymer by the heating unit is not particularly limited and may be suitably selected in accordance with the intended use. For example, the heating temperature can be controlled by the output power of the heating unit, conveyance speed, atmospheric temperature, etc.

The time for making the film composed of crystalline polymer into contact with the heating unit is not particularly limited and a time period required to satisfactorily proceed with the intended semi-burning may be suitably selected. It is however, preferably 5 seconds to 120 seconds, more preferably 10 seconds to 90 seconds, particularly preferably 20 seconds to 80 seconds.

The heating treatment in the asymmetrically heating step may be continuously performed or may be performed intermittently in a divided manner in several times.

When the heating is continuously performed, in order to hold a temperature gradient by a heated surface and a non-heated surface of the film composed of crystalline polymer, heating of the heated surface is preferably performed simultaneously with cooling of the non-heated surface.

The method of cooling the non-heated surface is not particularly limited and may be suitably selected in accordance with the intended use. Examples thereof include a method of blowing cold air; a method of making the non-heated surface in contact with a cooling medium; a method of making the non-heated surface in contact with a cooled material; and a method of leaving the non-heated surface to cool. Among these methods, preferred is a method of making the non-heated surface in contact with a cooled material.

The cooled material is not particularly limited and may be suitably selected in accordance with the intended use. However, a cooling roll is preferable in that semi-burning can be continuously performed in an industrial line production just as in the heating of the heated surface, and it is easy to control the temperature thereof and to perform maintenance of the device. The temperature of the cooling roll is not particularly limited and may be suitably adjusted so as to obtain the temperature difference required for producing a semi-burned product. The time for making the film composed of crystalline polymer into contact with the cooling roller is not particularly limited and a time period required to satisfactorily proceed with the intended semi-burning may be suitably selected. It is however, preferably 5 seconds to 120 seconds, more preferably 10 seconds to 90 seconds, particularly preferably 20 seconds to 80 seconds.

When the heating treatment is performed intermittently, it is preferred that the heated surface of the film composed of the crystalline polymer be intermittently heated and the non-heated surface be intermittently cooled to suppress an increase in non-heated surface temperature.

### —Stretching Step—

It is preferable that the semi-burned film be subsequently stretched. The stretching is preferably in both directions of a longitudinal direction and a width direction. The semi-burned film may be stretched in the longitudinal direction and the width direction one after the other, and may be biaxially stretched in these directions at the same time.

When the semi-burned film is stretched in n the longitudinal direction and the width direction one after the other, it is preferred to first perform the stretching in the longitudinal direction and then perform the stretching in the width direction.

The draw ratio of the semi-burned film in the longitudinal direction is preferably 3 times to 100 times, more preferably 4 times to 90 times, particularly preferably 5 times to 80 times. The stretching temperature in the longitudinal direction is preferably 100° C. to 320° C., more preferably 200° C. to 310° C., particularly preferably 250° C. to 300° C. The stretching temperature in the longitudinal direction is preferably 100° C. to 320° C., more preferably 200° C. to 310° C., particularly preferably 250° C. to 300° C.

The draw ratio of the semi-burned film in the width direction is preferably 3 times to 100 times, more preferably 5 times to 90 times, still more preferably 7 times to 70 times, particularly preferably 10 times to 40 times. The stretching temperature in the width direction is preferably 100° C. to 320° C., more preferably 200° C. to 310° C., particularly preferably 250° C. to 300° C.

The area draw ratio is preferably 10 times to 300 times, more preferably 20 times to 280 times, particularly preferably 30 times to 200 times. When the stretching is performed, the semi-burned film may be pre-heated to a temperature equal to or lower than the stretching temperature beforehand.

Note that after being stretched, the semi-burned film can be thermally fixed as required. Typically, the thermal fixation temperature is preferably equal to or higher than the stretching temperature and lower than the melting point of the burned crystalline polymer film.

### —Hydrophilicating Step—

The hydrophilicating step is a step of subjecting the stretched film to hydrophilication treatment.

Examples of the hydrophilication treatment include (1) the stretched film is impregnated with ketones and then exposed to an ultraviolet laser, and (2) chemical etching treatment.

As water-soluble ketones usable in the treatment (1) the stretched film is impregnated with ketones and then exposed to an ultraviolet laser, include acetone, and methylethylketone. Among these, acetone is particularly preferable. The concentration of the water-soluble ketone at the stage of impregnating the stretched film therewith slightly varies depending on the material of the crystalline polymer microporous membrane and the size of thin holes. However, when one of acetone and methylethylketone is used as the water-soluble ketone, the concentration thereof is preferably 85% by mass to 100% by mass. Meanwhile, the concentration of the water-soluble ketone inside the crystalline polymer microporous membrane when the film is exposed to an ultraviolet laser is, as an absorbance at a wavelength of the ultraviolet ray laser used, preferably 0.1 to 10. For instance, when acetone is used as the water-soluble ketone and KrF is used as a light source, this absorbance is equivalent to the concentration of acetone of 0.05% by mass to 5% by mass. In this case, the absorbance is preferably 0.1 to 6, more preferably 0.5 to 5. When a crystalline polymer microporous membrane containing a water-soluble ketone in this concentration range is exposed to an ultraviolet laser beam, satisfactory hydrophilication effect can be obtained with a radiation exposure dose greatly lower than in conventional hydrophilication process.

In general, when a water-soluble ketone having a boiling point of 50° C. to 100° C. is used, the effect of hydrophilication through radiation of an ultraviolet laser is high, and the solvent is easily removed after the hydrophilication treatment. However, when a water-soluble ketone having a boiling point higher than 100° C. is used, it is difficult to remove the ketone after the hydrophilication treatment.

On the occasion that an ultraviolet laser beam is irradiated to the crystalline polymer microporous membrane impregnated with a water-soluble ketone to hydrophilicate the membrane, in order to obtain high and homogenous hydrophilication effect, the crystalline polymer microporous membrane impregnated with the water-soluble ketone is further impregnated with water to control the concentration of the aqueous solution of water-soluble ketone in the crystalline polymer microporous membrane so that the absorbance at a wavelength of the ultraviolet laser beam used is 0.1 to 10, preferably 0.1 to 6, particularly preferably 0.5 to 5. When the absorbance is lower than 0.1, it may be difficult to obtain a sufficient effect of hydrophilication. When the absorbance is higher than 10, the absorption amount of light energy by the aqueous solution is increased, and it may be difficult to sufficiently hydrophilicate the crystalline polymer microporous membrane to the inside of micropores.

As a method of impregnating the crystalline polymer microporous membrane with water in order to control the concentration of the aqueous solution of water-soluble ketone in the membrane, it is preferable that the membrane be impregnated with an aqueous solution having an extremely low concentration of the same ketone.

The term “absorbance” means an amount of light defined by the following relationship.

Absorbance=log₁₀(I₀/I)=εcd

In the relationship, ε denotes an absorptivity coefficient of ketone; c denotes a concentration (mol/dm³) of a ketone aqueous solution; d denotes an optical path length (cm) of a transmitted light, I₀ denotes a light transmission intensity of a solvent alone; and I denotes a light transmission intensity of the solution. In the present invention, a concentration of the aqueous solution with which the absorbance is x means such a concentration that the absorbance is x when measured with a measurement cell having d (optical path length) of 1 cm. However, in the case of an aqueous solution having a high concentration at which a measurement of absorbance is difficult to perform with d=1 cm due to too little amount of transmitted light, an absorbance obtained by using a measurement cell of d=0.2 cm is multiplied by five, and the resulting value was regarded as the absorbance.

The method of impregnating the crystalline polymer microporous membrane with an aqueous solution of the water-soluble ketone is not particularly limited and may be suitably selected in accordance with the intended use. The method may be selected from immersion method, spraying method, coating method etc. according to the form of the crystalline polymer microporous membrane, the size thereof, and the like. Among these methods, immersion method is usually employed.

An impregnation temperature of the water-soluble ketone or the aqueous solution thereof is preferably 10° C. to 40° C., from the viewpoint of the diffusion speed of the aqueous solution into micropores of the crystalline polymer microporous membrane. When the impregnation temperature is lower than 10° C., a relative long time is required for the aqueous solution to diffuse into the micropores. When the impregnation temperature is higher than 40° C., undesirably, the evaporation speed of the water-soluble ketone is increased.

After the concentration of the water-soluble ketone contained in the crystalline polymer microporous membrane that has been subjected to the impregnation is controlled so as to be in the above range, the resulting crystalline polymer microporous membrane is then subjected to the following radiation exposure with ultraviolet laser beam.

The ultraviolet laser beam preferably has a wavelength of 190 nm to 400 nm. For example, argon-ion laser beam, krypton-ion laser beam, N₂ laser beam, dye laser beam, and excimer laser beam are exemplified. Excimer laser beam is suitable. Among these, particularly preferred are KrF excimer laser beam (wavelength: 248 nm), ArF excimer laser beam (wavelength: 193 nm) and XeCl excimer laser beam (308 nm) which enable stably obtaining high output power for a long period of time.

The radiation exposure with the excimer laser beam is commonly carried out at room temperature and in the air, but in the present invention, it is preferable to perform it in a nitrogen atmosphere. Conditions of the radiation exposure with excimer laser beam depend on the type of fluorine resin used and the desired degree of surface modification. Typical conditions for radiation exposure are as follows:
Fluence: 10 mJ/cm²/pulse or higher
Incident energy: 0.1J/cm²or more
Common conditions of radiation exposure with particularly suitably used KrF excimer laser beam, ArF excimer laser beam, and XeCl excimer laser beam are as follows:
KrF fluence 50 mJ/cm²/pulse to 500 mJ/cm²/pulse
Incident energy: 0.25 J/cm² to 3.0 J/cm²
ArF fluence:10 mJ/cm²/pulse to 200 mJ/cm²/pulse
Incident energy: 0.1 J/cm² to 3.0 J/cm²
XeCl fluence 50 mJ/cm²/pulse to 500 mJ/cm²/pulse
Incident energy: 3.0 J/cm² to 30.0 J/cm²

As the above-mentioned (2) chemical etching treatment, oxidative destruction treatment is exemplified in which a fluorine resin constituting the crystalline polymer microporous membrane is modified using an alkali metal, and the modified portions are removed.

The oxidative destruction treatment is carried out using, for example, an organic alkali metal solution. When the crystalline polymer microporous membrane is subjected to a chemical etching treatment with an organic alkali metal solution, the surface of the crystalline polymer microporous membrane is modified so that hydrophilicity is imparted to the crystalline polymer microporous membrane and a brownish layer is formed thereon. This brownish layer is composed of sodium fluoride, a decomposed product of fluororesin having a carbon-carbon double bond, and polymers from these substances, naphthalene and anthracene. These substances are preferably removed therefrom because they may be left out, dissolved, and/or eluted, and thereby mixed in a filtration liquid. These substances can be removed by oxidative destruction with use of hydrogen peroxide, hypochlorous acid soda, ozone, etc.

The chemical etching treatment can be performed using an organic alkali metal solution etc. Specifically, this can be performed by immersing the crystalline polymer microporous membrane in an organic alkali metal solution. In this case, since the crystalline polymer microporous membrane is subjected to a chemical etching treatment from its surface, it is also possible to provide only portions in proximity to the both surfaces of the membrane with the chemical etching treatment. However, in order to increase the water retention of the crystalline polymer microporous membrane, it is preferable to provide not only the portions in proximity to the both surfaces of the crystalline polymer microporous membrane but also the inside of the membrane with the chemical etching treatment. If the chemical etching treatment is provided to the inside of the crystalline polymer microporous membrane, reduction in function as a separation membrane is suppressed.

As the organic alkali metal solution for use in the chemical etching treatment, there are exemplified organic solvent solutions of methyl lithium, a metallic sodium-naphthalene complex, tetrahydrofuran of a metallic sodium-anthracene complex, etc.; and solutions of metallic sodium-liquid ammonia. Among these, typically, a solution of a complex between metallic sodium and an aromatic anion-radical as naphthalene is widely used, however, in order to provide the chemical etching treatment to the inside of the crystalline polymer microporous membrane, it is preferable to use benzophenon, anthracene or biphenyl as the aromatic anion radical.

### <Crystalline Polymer Microporous Membrane>

One the characteristics of a crystalline polymer microporous membrane produced by the method for producing a crystalline polymer microporous membrane of the present invention is that an in-plane distribution of average pore size is homogenous.

The in-plane variation of average pore size of the crystalline polymer microporous membrane is preferably produced at a coefficient of variation of 20% or lower, more preferably 15% or lower. When the coefficient of variation is higher than 20%, the diameter of trapped particles may become large because of the excessively large variation of pore size.

The in-plane distribution of average pore size can be determined and evaluated with a measurement value of bubble point, according to the following method. Specifically, the in-plane distribution of average pore size is determined by an initial bubble point value (equivalent to a maximum pore diameter) using a syringe holder having a diameter of 25 mm and an IPA liquid as a wetting agent. The microporous membrane is cut out into a square of 400 mm on a side, and the square-shaped membrane is equally divided into 100 pieces of squares each having 40 mm on a side, followed by measurement of a bubble point. Thereafter, an average value and a coefficient of variation can be determined from the bubble point.

The coefficient of variation is represented by a ratio of a standard deviation of an average value of measured values to the average value of the measured values (standard deviation of an average value of measured values/the average value of measured values). When an average value of the number of measured values “n” (X1, X2 . . . . Xn) is defined as Xm and the standard deviation is represented by Sx, a coefficient of variation Vx can be calculated by the following equation.

Coefficient of variation [%]; Vx=Sx/Xm×100

Further, one of the characteristics of the crystalline polymer microporous membrane of the present invention is that the average pore size of a non-heated surface is greater than that of a heated surface.

In the crystalline polymer microporous membrane, provided that a film thickness of the crystalline polymer microporous membrane is represented by X, an average pore size of a portion with a thickness of X/10 in a depth direction from a non-heated surface of the crystalline polymer microporous membrane is represented by P1, and an average pore size of a portion with a thickness of 9X/10 in the depth direction from the non-heated surface is represented by P2, a value of P1/P2 is preferably 2 to 10,000, more preferably 3 to 100, particularly preferably 4.5 to 100.

Also, in the crystalline polymer microporous membrane, a ratio of an average pore size of the non-heated surface to an average pore size of the heated surface (an average pore size ratio of non-heated surface/heated surface) is preferably 5 times to 30 times, more preferably 10 times to 25 times, still more preferably 15 times to 20 times.

Note that the average pore size of the polytetrafluoroethylene microporous membrane was measured as follows. An image (SEM images, at a magnification of 1,000 times to 5,000 times) of a membrane surface is taken by a scanning electron microscope (Hitachi Model S-4000, deposition: Hitachi Model E1030, both manufactured by Hitachi Ltd.), the resulting image is taken into an image processor (name of image processor: TV Image Processor TVIP-4100II, available from Avionics Japan; name of software: TV Image Processor IMAGE COMMAND 4198, available from RATOC System Engineering Co., Ltd.) to obtain an image including only polytetrafluoroethylene fibers, and the image is arithmetically processed to thereby determine an average pore size of the polytetrafluoroethylene microporous membrane.

In addition to the characteristics described above, the crystalline polymer microporous membrane of the present invention includes an aspect (a first aspect) in which the average pore size continuously varies from the non-heated surface toward the heated surface; and in addition to the first aspect, an aspect (second aspect) in which the crystalline polymer microporous membrane has a single-layer structure. By further including these additional characteristics, the filtration life of the crystalline polymer microporous membrane can be effectively extended.

The description “the average pore size continuously varies from the non-heated surface toward the heated surface” in the first aspect means that when a distance d in a thickness direction from the non-heated surface is mapped as a horizontal axis of a graph, and an average pore size D is mapped as a vertical axis of the graph, the resulting graph is depicted with a continuous straight line. A graph depicted from the non-heated surface (d=0) to the heated surface (d=film thickness) may be composed only of a negative slope region (dD/dt<0), may include a negative slope region and a region having a slope of zero (dD/dt=0) in a mixed manner, and may include a negative slope region and a positive slope region (dD/dt>0) in a mixed manner. Preferred is one of a graph composed only of a negative slope region (dD/dt<0) and a graph including a negative slope region and a region having a slope of zero (dD/dt=0) in a mixed manner. Particularly preferred is a graph composed only of a negative slope region (dD/dt<0).

The negative slope region preferably contains at least a non-heated surface of the membrane. In the negative slope region (dD/dt<0), the degree of the slope may be constant or may be inconstant. For instance, when the crystalline polymer microporous membrane of the present invention is represented by a graph composed only of a negative slope region (dD/dt<0), the crystalline polymer microporous membrane can take an aspect in which a value of dD/dt in the heated surface is greater than that in the non-heated surface. Also, the crystalline polymer microporous membrane can take an aspect in which the value of dD/dt is gradually increased from the non-heated surface toward the heated surface thereof.

The term “single-layer structure” described in the second aspect excludes a multi-layered structure which is formed so that two or more layers are bonded together, or stacked one on top on the other. That is, the term “single-layer structure” described in the second aspect means a structure having no boundary surface between layers existing in a multi-layered structure. In the second aspect, it is preferable that a surface having an average pore size which is smaller than that of the non-heated surface and greater than that of the heated surface be present in the membrane.

The crystalline polymer microporous membrane of the present invention is preferably provided with both of the characteristics of the first and second aspects. In other words, preferred is a crystalline polymer microporous membrane in which the average pore size of a non-heated surface is greater than that of a heated surface and the average pore size continuously varies from the non-heated surface toward the heated surface, and which has a single-layer structure. Use of such a crystalline polymer microporous membrane, it is possible to further efficiently trap microparticles when filtration is performed from the non-heated surface side, and greatly extend the filtration life. In addition, the crystalline polymer microporous membrane can be produced with ease at low costs.

The film thickness of the crystalline polymer microporous membrane of the present invention is not particularly limited and may be suitably selected in accordance with the intended use. It is however preferably 1 μm to 300 μm, more preferably 5 μm to 100 μm, particularly preferably 10 μm to 80 μm.

The crystalline polymer microporous membrane of the present invention can trap particles without causing leakage thereof even used in a large area. Therefore, the area of the crystalline polymer microporous membrane is not particularly limited and may be suitably adjusted in accordance with the intended use. It is however preferably greater than 0.04 m² and equal to or smaller than 10 m², more preferably 0.1 m²to 5 m².

The crystalline polymer microporous membrane of the present invention has a variety of uses and can be especially suitably used for the filtration filter described below.

### (Filtration Filter)

The filtration filter of the present invention is characterized by using the crystalline polymer microporous membrane of the present invention.

When the crystalline polymer microporous membrane of the present invention is used for the filtration filter, filtration is carried out with its non-heated surface (surface having a larger average pore size) being positioned on the inlet side. In other words, the surface having a larger average pore size is used as the filtration surface of the filter. By carrying out filtration with the surface having a larger average pore size positioned on the inlet side, it is possible to efficiently trap fine particles.

Also, since the crystalline polymer microporous membrane of the present invention has a large specific surface area, fine particles introduced from the surface having a larger average pore size can be removed by adsorption or adhesion before reaching a portion having the smallest pore size. Therefore, the filter hardly allows clogging to occur and can sustain high filtration efficiency for a long period of time.

The filtration filter of the present invention is capable of filtration at least at a rate of 5 mL/cm²·min or higher when filtration is carried out at a differential pressure of 0.1 kg/cm².

Examples of the shape of the filtration filter of the present invention include a pleated shape in which a filtration membrane is pleated, a spiral shape in which a filtration membrane is rolled in the form of a roll, a frame-and-plate shape in which disc-shaped filtration membranes are stacked on top of one another, and a tube shape in which a filtration membrane is formed as a tube. Among these, a pleated shape is particularly preferred in that the effective surface area used for filtration per cartridge can be used.

Filter cartridges are classified into element exchange type filter cartridges in which only filter elements need to be replaced when degraded filtration membranes are replaced, and capsule-type filter cartridges in which filter elements and a filtration housing are formed in an integral unit and both the filtration elements and the housing are used in a disposal manner.

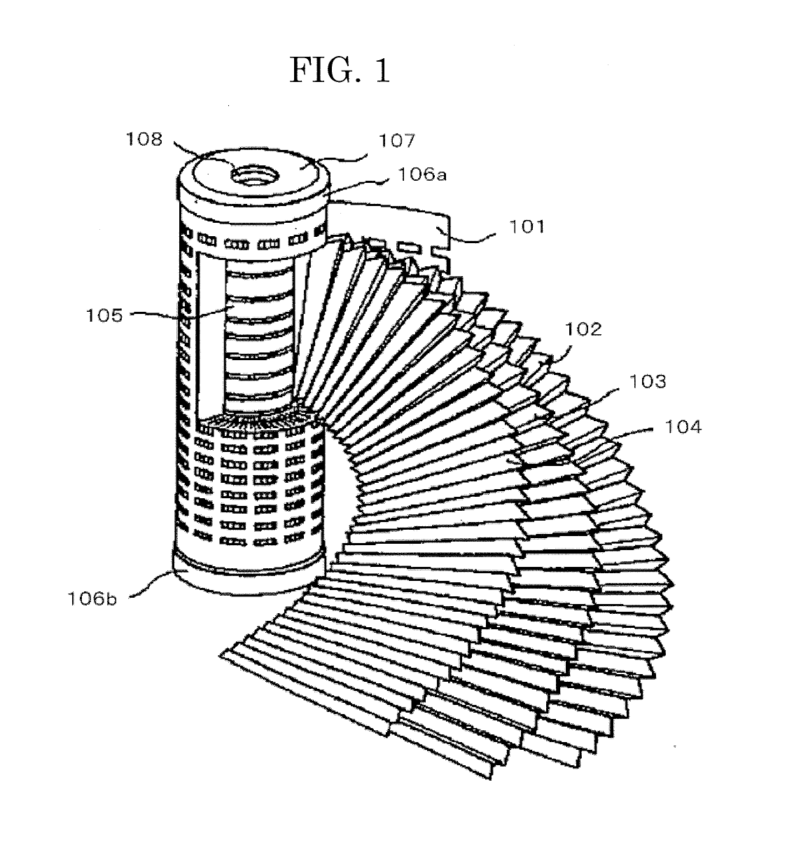

FIG. 1 is a developed view illustrating the structure of an element exchange type pleated filter cartridge element. Sandwiched between two membrane supports 102 and 104, a microfiltration membrane 103 is pleated and wound around a core 105 having multiple liquid-collecting slots, and a cylindrical body is thus formed. An outer circumferential cover 101 is provided outside the foregoing members so as to protect the microfiltration membrane. At both ends of the cylindrical body, the microfiltration membrane is sealed with end plates 106a and 106b. The end plates 106a and 106b are connected to a seal portion of a filter housing (not illustrated), via a gasket 107. A filtrated liquid is collected through the liquid-collecting slots of the core 105 and discharged from a fluid outlet 108.

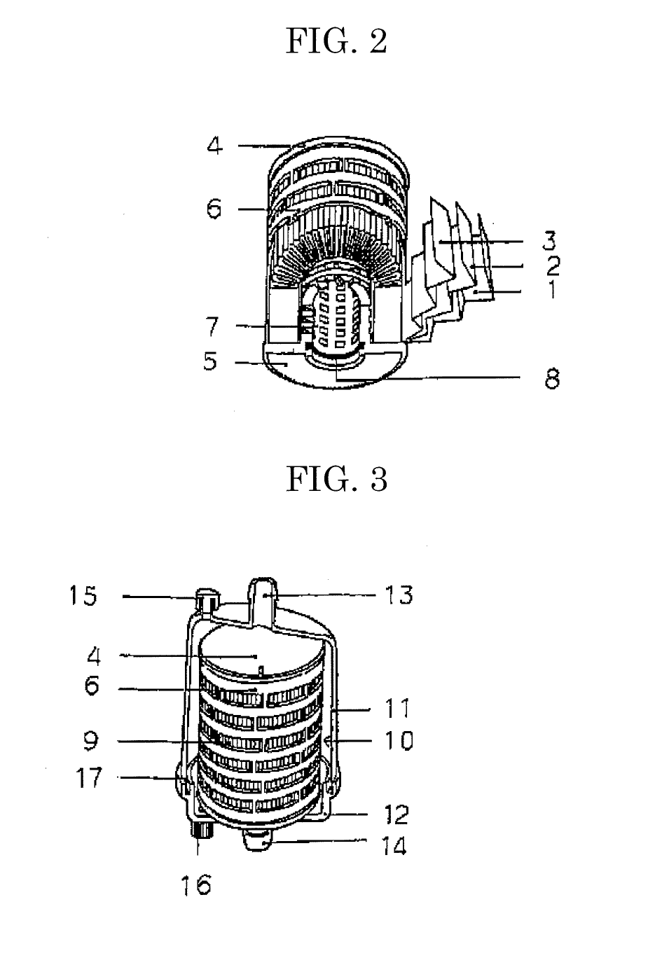

Capsule-type pleated filter cartridges are illustrated in FIGS. 2 and 3.

FIG. 2 is a developed view illustrating the overall structure of a microfiltration membrane filter element before mounted in a housing of a capsule-type filter cartridge. Sandwiched between two supports 1 and 3, a microfiltration membrane 2 is pleated and wound around a filter element core 7 having multiple liquid-collecting slots, and a cylindrical body is thus formed. A filter element cover 6 is provided outside the foregoing members so as to protect the microfiltration membrane. At both ends of the cylindrical body, the microfiltration membrane is sealed with an upper end plate 4 and a lower end plate 5.

FIG. 3 illustrates a capsule-type pleated filter cartridge in which a filter element is incorporated into a housing so as to form an integral unit. A filter element 10 is incorporated in a housing composed of a housing base and a housing cover. The lower end plate is connected in a sealed manner to a water-collecting tube (not illustrated) at the center of the housing base by means of an O-ring 8. A liquid enters the housing from a liquid inlet nozzle 13 and passes through a filter medium 9, and then the liquid is collected through the liquid-collecting slots of the filter element core 7 and discharged from a liquid outlet nozzle 14. Generally, the housing base and the housing cover are thermally fused in a liquid-tight manner at a fusing portion 17.

In FIG. 3, reference numeral 11 denotes a housing cover, reference numeral 12 denotes a housing base, reference numeral 15 denotes an air vent, and reference numeral 16 denotes a drain.

FIG. 2 illustrates an instance in which the lower end plate and the housing base are connected in a sealed manner by means of the O-ring 8. The lower end plate and the housing base may be connected in a sealed manner by thermal fusing or with an adhesive. Also, the housing base and the housing cover may be connected in a sealed manner with an adhesive as well as by thermal fusing. FIGS. 1 to 3 illustrate specific examples of microfiltration filter cartridges, and the present invention is not confined to the examples illustrated in these drawings.

Having a high filtering function and a long lifetime as described above, the filtration filter using the crystalline polymer microporous membrane of the present invention enables a filtration device to be compact. In a conventional filtration device, multiple function units are used and arranged in a parallel manner to offset the short filtration life. Use of the filtration filter of the present invention makes it possible to greatly reduce the number of filtration units used in a parallel manner. Furthermore, it is also possible to greatly extend the period of time for which the filter can be used without replacement, and thus making it possible to cut costs and time necessary for maintenance.

The filtration filter of the present invention can be used in a variety of situations where filtration is required, notably in microfiltration of gases, liquids, etc. For instance, the filtration filter can be used for filtration of corrosive gases and gases for use in semiconductor industries, and for filtration and sterilization of washing water for use in the electronics industries, water for medical use, water for pharmaceutical production processes and water for use in food. In particular, since the filtration filter of the present invention is superior in heat resistance and chemical resistance, it can be effectively used for high-temperature filtration and filtration of reactive chemicals, for which conventional filtration filters cannot be suitably used.

### EXAMPLES

Hereinafter, the present invention will be further described with reference to specific Examples, however, the present invention shall not be construed as being limited to these disclosed Examples.

### Example 1

### <Production of Crystalline Polymer Microporous Membrane>

Into 100 parts by mass of a polytetrafluoroethylene fine powder having a number average molecular weight of 6,200,000 (“POLYFLON FINE POWDER F104U” produced by Daikin Industries Ltd.), 27 parts by mass of a hydrocarbon oil (“ISOPER” available from Esso Oil Co., Ltd.), as an extrusion-aiding agent, were added, and the mixture was paste-extruded in the form of a round bar. The paste was calendered by a calender roll heated at 60° C. at a speed of 30 m/min to produce a polytetrafluoroethylene film. The polytetrafluoroethylene film was passed through a hot air drying oven heated to 250° C. so as to dry and remove the extrusion-aiding agent, thereby producing an unburned polytetrafluoroethylene film having an average thickness of 120 μm, an average width of 150 mm and a specific gravity of 1.55.

With use of a single sided heater illustrated in FIG. 4, one surface of the resulting polytetrafluoroethylene was brought into contact with an endless belt (at “48” in FIG. 4) which was heated at 345° C., for 30 seconds, by a pressing belt unit (at “41” in FIG. 4) at a pressing pressure of 1 MPa to thereby produce a semi-burned film.

The following describes the structure of the single-sided heater illustrated in FIG. 4.
Endless belt heater (“46” in FIG. 4)
   Heater (“47” in FIG. 4):
      Output: 5 KW; Size: MD 1,000 mm; Width: 300 mm
   Non-heating rolls (“49” in FIG. 4):
      Diameter: 100 mm; Material: steel
   Endless belt (“48” in FIG. 4):
      Width: 300 mm; Length: 2,314 mm; Thickness: 0.2 mm; Material:
SUS304H
   Pressing belt unit (“41” in FIG. 4)
      Endless belt (“43” in FIG. 4):
         Width: 300 mm; Length: 2,314 mm; Thickness: 0.2 mm; Material:
SUS304H
   Endless belt rolls (“45” in FIG. 4)
      Diameter: 100 mm; Material: steel

The resulting semi-burned film was stretched 13 times the original length in a longitudinal direction at 270° C. and wound around a winding reel once. Afterward, the film is pre-heated to 305° C. and then stretched 12 times in a width direction at 270° C. with both ends thereof being held by clips. Thereafter, the film was thermally fixed at 380° C. An area-stretching magnification of the resulting stretched film was 120 times by expansion area magnification. With the procedure described above, a polytetrafluoroethylene microporous membrane of Example 1 was produced.

### Example 2

A polytetrafluoroethylene microporous membrane of Example 2 was produced in the same manner as in Example 1 except that a single-sided heater as illustrated in FIG. 5 was used instead of the single sided heater in Example 1.

The following describes the structure of the single-sided heater illustrated in FIG. 5.
Heating roll (heater) (“51” in FIG. 5)
   Induction heating system, Diameter: 300 mm; Width: 300 mm;
Material: steel
   Pressing belt unit (“41” in FIG. 5)
      Endless belt (“43” in FIG. 5):
      Width: 300 mm; Length: 1,800 mm; Thickness: 0.2 mm; Material:
SUS304H
   Endless belt rolls (“45” in FIG. 5)
      Diameter: 100 mm; Material: steel

### Example 3

A polytetrafluoroethylene microporous membrane of Example 3 was produced in the same manner as in Example 1 except that a single-sided heater as illustrated in FIG. 6 was used instead of the single sided heater in Example 1.

The following describes the structure of the single-sided heater illustrated in FIG. 6.
Endless belt heater (“65” in FIG. 6)
   Endless belt (“66” in FIG. 6):
      Width: 300 mm; Length: 2,100 mm; Thickness: 0.2 mm; Material:
SUS304H
   Heating rolls (2 rolls) (“67” in FIG. 6):
      Induction heating system, Width: 300 mm; Diameter: 200 mm;
Material: steel
   Steel roll (pressing unit) (“61” in FIG. 6)
      Diameter: 300 mm; Width: 300 mm; Material steel

### Example 4

A polytetrafluoroethylene microporous membrane of Example 4 was produced in the same manner as in Example 1 except that a single-sided heater as illustrated in FIG. 7 was used instead of the single sided heater in Example 1.

The following describes the structure of the single-sided heater illustrated in FIG. 7.
Heating roll (heater) (“51” in FIG. 7)
   Induction heating system, Diameter: 300 mm; Width: 300 mm;
Material: steel
   Pressing roll sheet (“71” in FIG. 7)
      UPILEX 75S (produced by Ube Industries Ltd.)

Note that in FIG. 7, numerical reference “73” denotes a film composed of crystalline polymer, and the arrow indicates a direction of tension loaded.

### Example 5

A polytetrafluoroethylene microporous membrane of Example 5 was produced in the same manner as in Example 1 except that a single-sided heater as illustrated in FIG. 8 was used instead of the single sided heater in Example 1 and a semi-burned film was produced according to the following manner.

With use of the single-sided heater illustrated in FIG. 8, one surface of the resulting polytetrafluoroethylene was heated while being fixed to an endless belt (heated at 345° C.) (“84” in FIG. 8) of a suction belt unit (“81” in FIG. 8) for 30 seconds to thereby produce the semi-burned film.

The following describes the structure of the single-sided heater illustrated in FIG. 8.
Suction belt unit (suction unit, heating unit) (“81” in FIG. 8)
   Suction hole (“83” in FIG. 8):
      Hole diameter: 0.5 mm; Center distance: MD 10 mm, TD 10 mm
   Endless belt (“84” in FIG. 8):
      Width: 300 mm; Length: 2,100 mm, Thickness: 0.2 mm; Material:
SUS304H; Rate of hole area: 0.79%
   Vacuum box (“85” in FIG. 8):
      Length: 1,000 mm; Width: 280 mm: Suction forth: 15 KPa
      Heating rolls (two rolls) (“82” in FIG. 8)
         Induction heating system, Width: 300 mm; Diameter: 200 mm;
Material: steel

### Example 6

A polytetrafluoroethylene microporous membrane of Example 6 was produced in the same manner as in Example 5 except that a single-sided heater as illustrated in FIG. 9 was used instead of the single sided heater in Example 5.

The following describes the structure of the single-sided heater illustrated in FIG. 9.
Suction heating roll unit (suction unit, heating unit) (“91” in FIG. 9)
   Suction hole (“92” in FIG. 9)
      Hole diameter: 0.5 mm; Center distance: MD 10 mm, TD 10 mm
   Roll (“93” in FIG. 9)
      Induction heating system, Diameter: 300 mm; Width: 280 mm;
Material: SUS304H; Rate of hole area: 0.79%; Suction force: 15 KPa

### Example 7

A polytetrafluoroethylene microporous membrane of Example 7 was produced in the same manner as in Example 1 except that after a stretched film was produced, the stretched film was subjected to a hydrophilication treatment described below.

### —Hydrophilication Treatment—

In hydrogen peroxide water (concentration: 0.03% by mass), a stretched film that had been preliminarily impregnated with ethanol was immersed (liquid temperature: 40° C.), and 20 hours later, the stretched film was taken out therefrom. The stretched film was exposed to an ArF excimer laser beam (wavelength: 193 nm) from above at a fluence of 25 mJ/cm²/pulse, a irradiation dose of 10 J/cm² thereby producing a hydrophilicated polytetrafluoroethylene microporous membrane.

The wettability of the microporous membrane was measured as follows. After being sufficiently washed with pure water, and then dried, the wettability was measured using a wettability index standard liquid defined in JIS K6768. Specifically, the wettability index of a microporous membrane can be measured by successively dropping on a crystalline polymer microporous membrane a series of mixture liquids whose surface tensions continuously vary, and finding a highest surface tension of a mixture liquid when the crystalline polymer microporous membrane becomes wet with the mixture liquid. The highest surface tension can be determined as the wettability index of the microporous membrane. As a result, the microporous membrane was found to have a wettability index of 52 dyn/cm. This wettability index is significantly higher than the wettability index (31 dyn/cm) of a polytetrafluoroethylene microporous membrane which has not yet exposed to a ultraviolet laser beam. From this result, it was found that the wettability of the surface of fluorine resin was greatly improved by the hydrophilication treatment.

### Comparative Example 1

A polytetrafluoroethylene microporous membrane of Comparative Example 1 was produced in the same manner as in Example 1 except that one surface of the resulting film was heated with use of the single-sided heater of Example 1, but without using the pressing belt unit. The contact pressure between the unburned polytetrafluoroethylene film and the endless belt heater at this point in time was less than 0.01 MPa. The contact pressure was measured using a pressure measuring film (PRESCALE, produced by Fujifilm Holdings Corporation).

### Comparative Example 2

A polytetrafluoroethylene microporous membrane of Comparative Example 2 was produced in the same manner as in Example 2 except that one surface of the resulting film was heated with use of the single-sided heater of Example 2, but without using the pressing belt unit. The contact pressure between the unburned polytetrafluoroethylene film and the endless belt heater at this point in time was less than 0.01 MPa. The contact pressure was measured using a pressure measuring film (PRESCALE, produced by Fujifilm Holdings Corporation).

### Comparative Example 3

A polytetrafluoroethylene microporous membrane of Comparative Example 3 was produced in the same manner as in Example 5 except that one surface of the resulting film was heated with use of the single-sided heater of Example 5 without performing sucking action.

### Comparative Example 4

A polytetrafluoroethylene microporous membrane of Comparative Example 4 was produced in the same manner as in Example 6 except that one surface of the resulting film was heated with use of the single-sided heater of Example 6 without performing sucking action.

Next, each of the polytetrafluoroethylene microporous membranes produced in Examples 1 to 7 and Comparative Examples 1 to 4 was subjected to measurements of film thickness (average film thickness) and P1/P2 according to the following manners, in order to confirm whether the average pore size of the non-heated surface of the microporous membrane is greater than that of the heated surface and the average pore size continuously varies from the non-heated surface toward the heated surface. The measurement results are shown in Table 1.

### <Thickness of Film (Average Film Thickness)>

A thickness (average film thickness) of the polytetrafluoroethylene microporous membranes of Examples 1 to 7 and Comparative Examples 1 to 4 was measured using a dial-type thickness gauge (K402B, manufactured by ANRITSU Corp.). Specifically, arbitrarily selected three portions were measured on each of the polytetrafluoroethylene microporous membranes, and an average value was determined therefrom.

### <Measurement of P1/P2>

Each of the polytetrafluoroethylene microporous membranes of Examples 1 to 7 and Comparative Examples 1 to 4 was measured for P1/P2, where, provided that a film thickness of the microporous membrane is represented by X, P1 represents an average pore size of portions with a thickness of X/10 in a depth direction from the non-heated surface, and P2 represents an average pore size of portions with a thickness of 9X/10 in the depth direction of the non-heated surface.

The average pore size of the polytetrafluoroethylene microporous membrane was measured as follows. An image (SEM images, at a magnification of 1,000 times to 5,000 times) of a membrane surface was taken by a scanning electron microscope (Hitachi Model S-4000, deposition: Hitachi Model E1030, both manufactured by Hitachi Ltd.), the resulting image was taken into an image processor (name of image processor: TV Image Processor TVIP-4100II, available from Avionics Japan; name of software: TV Image Processor IMAGE COMMAND 4198, available from RATOC System Engineering Co., Ltd.) to obtain an image including only polytetrafluoroethylene fibers, and the image was arithmetically processed to thereby determine an average pore size of the polytetrafluoroethylene microporous membrane.

TABLE 1

| | Average | |
|---|---|---|
| | Membrane | |
| | Thickness | |
| | (μm) | P1/P2 |
| Ex. 1 | 50 | 4.8 |
| Ex. 2 | 50 | 4.7 |
| Ex. 3 | 50 | 4.8 |
| Ex. 4 | 50 | 4.7 |
| Ex. 5 | 50 | 4.5 |
| Ex. 6 | 50 | 4.7 |
| Ex. 7 | 50 | 4.7 |
| Comp. Ex. 1 | 52 | 4.1 |
| Comp. Ex. 2 | 53 | 4.2 |
| Comp. Ex. 3 | 52 | 4.3 |
| Comp. Ex. 4 | 54 | 4.2 |

The results shown in Table 1 demonstrated that in each of the polytetrafluoroethylene microporous membranes of Examples 1 to 7, the non-heated surface had an average pore size greater than that of the heated surface and the average pore size continuously varied from the non-heated surface toward the heated surface.

Meanwhile, each of the polytetrafluoroethylene microporous membranes of Comparative Examples 1 to 4 had a non-heated surface whose average pore size was greater than that of the heated surface and the average pore size continuously varied from the non-heated surface toward the heated surface, however, the film thicknesses of these films were slightly thicker than those of polytetrafluoroethylene microporous membranes of Examples 1 to 7 and also had a value of P1/P2 smaller than Examples 1 to 7.

### <Filtration Life Test>

The polytetrafluoroethylene microporous membranes of Examples 1 to 7 and Comparative Examples 1 to 4 were subjected to a filtration life test. The test was carried out according to the following manner.

Specifically, a latex dispersion liquid with a polydisperse particle size was used, and the filtration life was evaluated by an amount of filtration (L/m²) of the dispersion liquid, until which the filter actually caused clogging. In the present invention, the description “actually caused clogging” is defined as a point of time when the flow rate has decreased to one-half of the initial flow rate under a constant filtration pressure. The type of latex of the latex dispersion liquid for use in this measurement test is suitably selected according to the pore size of the membrane to be measured. The following are conditions for selecting a latex. Particles contained in a filtered liquid has a concentration of 1 ppm or less, and a ratio of the average particle diameter of the latex to the pore size of the membrane is 1/5 to 5. As a dispersion medium, isopropanol was used and the filtration test was performed with the latex dispersion liquid at a concentration of 100 ppm. The results are shown in Table 2.

TABLE 2

| | Filtration Life |
|---|---|
| | Test |
| Ex. 1 | 520 L/m² |
| Ex. 2 | 510 L/m² |
| Ex. 3 | 510 L/m² |
| Ex. 4 | 520 L/m² |
| Ex. 5 | 500 L/m² |
| Ex. 6 | 500 L/m² |
| Ex. 7 | 500 L/m² |
| Comp. Ex. 1 | 460 L/m² |
| Comp. Ex. 2 | 470 L/m² |
| Comp. Ex. 3 | 470 L/m² |
| Comp. Ex. 4 | 460 L/m² |

The results shown in Table 2 demonstrated that the polytetrafluoroethylene microporous membranes of Examples 1 to 7 were superior in filtration life to the polytetrafluoroethylene microporous membranes of Comparative Examples 1 to 4.

### <Flow Rate Test>

The polytetrafluoroethylene microporous membranes of Examples 1 to 7 and Comparative Examples 1 to 4 were subjected to a flow rate test.

The flow rate test was carried out according to the procedure of JIS K3831, under the following conditions. As the type of testing method, “pressure-applied filtration test method” was employed. As a test sample, the membrane was cut out in a circle having a diameter of 13 mm, and set on a stainless-steel holder. As a test liquid, isopropanol was used, and the time required to filter 100 mL of the test liquid at a pressure of 100 KPa was measured, and a flow rate (L/min·m²) was calculated therefrom. The results are shown in Table 3.

TABLE 3

| | Flow Rate Test |
|---|---|
| Ex. 1 | 1,700 L/min · m² |
| Ex. 2 | 1,600 L/min · m² |
| Ex. 3 | 1,700 L/min · m² |
| Ex. 4 | 1,700 L/min · m² |
| Ex. 5 | 1,700 L/min · m² |
| Ex. 6 | 1,700 L/min · m² |
| Ex. 7 | 1,700 L/min · m² |
| Comp. Ex. 1 | 1,400 L/min · m² |
| Comp. Ex. 2 | 1,300 L/min · m² |
| Comp. Ex. 3 | 1,200 L/min · m² |
| Comp. Ex. 4 | 1,200 L/min · m² |

The results shown in Table 3 demonstrated that each of the polytetrafluoroethylene microporous membranes of Examples 1 to 7 was superior in flow rate to the polytetrafluoroethylene microporous membranes of Comparative Examples 1 to 4.

### <Measurement of Pore Size Distribution>

The polytetrafluoroethylene microporous membranes of Examples 1 to 7 and Comparative Examples 1 to 4 were measured for in-plane pore size distribution. The pore size distribution was evaluated with bubble point measurement according to the following method. A syringe holder having a diameter of 25 mm was used. As a wetting agent, IPA was used, and an initial bubble point value (equivalent to a maximum pore size) was used as a measurement value. Each of the microporous membranes was cut out into a square of 400 mm on a side, and the square-shaped membrane was equally divided into 100 pieces of squares each having 40 mm on a side, followed by measurement of a bubble point. Thereafter, an average value and a coefficient of variation were determined from the bubble point. The results are shown in Table 4.

The coefficient of variation is represented by a ratio of a standard deviation of an average value of measured values to the average value of the measured values. When an average value of the number of measured values “n” (X1, X2 . . . Xn) is defined as Xm and the standard deviation is represented by Sx, a coefficient of variation Vx can be calculated by the following equation.

Coefficient of variation[%]; Vx=Sx/Xm×100

TABLE 4

| | Average Value | Coefficient of |
|---|---|---|
| | (kPa) | variation (%) |
| Ex. 1 | 43 | 1 |
| Ex. 2 | 44 | 0 |
| Ex. 3 | 43 | 1 |
| Ex. 4 | 44 | 2 |
| Ex. 5 | 45 | 1 |
| Ex. 6 | 43 | 0 |
| Ex. 7 | 45 | 1 |
| Comp. Ex. 1 | 42 | 21 |
| Comp. Ex. 2 | 42 | 21 |
| Comp. Ex. 3 | 41 | 22 |
| Comp. Ex. 4 | 42 | 22 |

The results shown in Table 4 demonstrated that each of the polytetrafluoroethylene microporous membranes of Examples 1 to 7 was uniformly heated by fixing one surface of its crystalline polymer film in the asymmetrically heating step, and each of the membranes had less in-plane variation in average pore size and had uniform pore size. It was possible to clearly confirm the effects of the present invention.

In contrast, the polytetrafluoroethylene microporous membranes of Comparative Examples 1 to 4 caused heating nonuniformity, and each of the stretched films had a large in-plane variation in average pore size, because the crystalline polymer membranes were not fixed in the asymmetrically heating step.

### Example 8

### —Assembling Filter Cartridge—

The polytetrafluoroethylene (PTFE) microporous membrane of Example 1 was pleated at a pleat width of 12.5 mm (pleated total width=220 mm) for 230 pleats. The polytetrafluoroethylene microporous membrane was sandwiched between other supports so as to have the following structure, and rolled in a cylindrical shape together with the other supports. Then, the edge margins of the cylindrical body were brought together and welded by an impulse sealer. Next, both ends of the cylindrical body were cut off at 15 mm, and the cut surfaces were thermally welded on polypropylene-end plates, thereby producing an element exchange type filter cartridge (Example 8).

### —Structure—

Upstream side: net, DELNET(RC-0707-20P) available from AET
Thickness: 0.13 mm, Basis weight: 31 g/m², Use area: approximately 1.3 m²

Upstream side: non-woven fabric, SYNTEX (PK-404N), produced by Mitsui Chemicals, Inc.
Thickness: 0.15 mm, Use area: approximately 1.3 m²

Filter medium: PTFE microporous membrane of Example 1
Thickness: approximately 0.05 mm, Use area: approximately 1.3 m²

Downstream side: net, DELNET(RC-0707-20P) available from AET
Thickness: 0.13 mm, Basis weight: 31 g/m², Use area: approximately 1.3 m²

### Example 9

A filter cartridge of Example 9 was produced in the same manner as in Example 8 except that the PTFE microporous membrane of Example 2 was used instead of the PTFE microporous membrane of Example 1.

### Example 10

A filter cartridge of Example 10 was produced in the same manner as in Example 8 except that the PTFE microporous membrane of Example 3 was used instead of the PTFE microporous membrane of Example 1.

### Example 11

A filter cartridge of Example 11 was produced in the same manner as in Example 8 except that the PTFE microporous membrane of Example 4 was used instead of the PTFE microporous membrane of Example 1.

### Example 12

A filter cartridge of Example 12 was produced in the same manner as in Example 8 except that the PTFE microporous membrane of Example 5 was used instead of the PTFE microporous membrane of Example 1.

### Example 13

A filter cartridge of Example 13 was produced in the same manner as in Example 8 except that the PTFE microporous membrane of Example 6 was used instead of the PTFE microporous membrane of Example 1.

### Example 14

A filter cartridge of Example 14 was produced in the same manner as in Example 8 except that the PTFE microporous membrane of Example 7 was used instead of the PTFE microporous membrane of Example 1.

### Comparative Example 5

A filter cartridge of Comparative Example 5 was produced in the same manner as in Example 8 except that the PTFE microporous membrane of Comparative Example 1 was used instead of the PTFE microporous membrane of Example 1.

### Comparative Example 6

A filter cartridge of Comparative Example 6 was produced in the same manner as in Example 8 except that the PTFE microporous membrane of Comparative Example 2 was used instead of the PTFE microporous membrane of Example 1.

### Comparative Example 7

A filter cartridge of Comparative Example 7 was produced in the same manner as in Example 8 except that the PTFE microporous membrane of Comparative Example 3 was used instead of the PTFE microporous membrane of Example 1.

### Comparative Example 8

A filter cartridge of Comparative Example 8 was produced in the same manner as in Example 8 except that the PTFE microporous membrane of Comparative Example 4 was used instead of the PTFE microporous membrane of Example 1.

Since the filter cartridges of Examples 8 to 14 according to the present invention were produced using the PTFE microporous membranes of Examples 1 to 7 according to the present invention, respectively, they were found to be superior in solvent resistance. Also, since the pore portions of the PTFE microporous membranes had an asymmetrical structure, these PTFE microporous membranes achieved high-flow rate and hardly allowed clogging to occur and exhibited a long filtration life.

### <Particle Retention Test (Use in Large Area: After Production of Cartridge)>

A particle retention test was performed on one hundred filter cartridges of Examples 8 to 14 and Comparative Examples 5 to 8. Specifically, an aqueous solution containing 0.01% by mass of polystyrene microparticles (average particle size: 0.9 μm) was filtered through each of the membranes at a differential pressure of 0.1 kg to determine presence or absence of leakage of particles. The results are shown in Table 5.

TABLE 5

| | Number of |
|---|---|
| | cartridges caused |
| | leakage of |
| | particles |
| Ex. 8 | 0 |
| Ex. 9 | 0 |
| Ex. 10 | 0 |
| Ex. 11 | 0 |
| Ex. 12 | 0 |
| Ex. 13 | 0 |
| Ex. 14 | 0 |
| Comp. Ex. 5 | 6 |
| Comp. Ex. 6 | 6 |
| Comp. Ex. 7 | 5 |
| Comp. Ex. 8 | 4 |

The results shown in Table 5 demonstrated that since the filter cartridges of Examples 8 to 14 were produced using the PTFE microporous membranes of Examples 1 to 7, in which uniform heating had been achieved with high accuracy, these filter cartridges had less variation in particle retention without causing leakage of particles. Even in the form of cartridges where a large area is required, these PTFE microporous membranes were found to have superior particle retention.

In contrast, since the filter cartridges of Comparative Examples 5 to 8 were produced using the PTFE microporous membranes of Comparative Examples 1 to 4 causing nonuniform heating, these PTFE microporous membranes had a relatively large variation in particle retention, caused leakage of particles when used in a large area, and accordingly, were found to be inferior in particle retention.

### INDUSTRIAL APPLICABILITY

Since the crystalline polymer microporous membrane of the present invention and a filtration filter using the crystalline polymer microporous membrane have a homogenous in-plane distribution of average pore size, are capable of efficiently trapping microparticles for a long period of time, have improved its scratch resistance and particle retention and are superior in heat resistance and chemical resistance, they can be used in a variety of situations where filtration is required notably in microfiltration of gases, liquids, etc. For instance, the crystalline polymer microporous membrane and the filtration filter can be used for filtration of corrosive gases and gases for use in semiconductor industries, and for filtration, sterilization and high-temperature filtration of washing water for use in the electronics industries, water for medical use, water for pharmaceutical production processes and water for use in food, and filtration of reactive chemicals.

### REFERENCE SIGNS LIST

1 upstream side support
2 microfiltration membrane
3 downstream side support
4 upper end plate
5 lower end plate
6 filter element cover
7 filter element core
8 O-ring
9 filter medium
10 filter element
11 housing cover
12 housing base
13 liquid inlet nozzle
14 liquid outlet nozzle
15 air vent
16 drain
17 fusing portion
41 pressing belt unit
43 endless belt
45 endless belt roll
46 endless belt heater
47 heater
48 endless belt
49 non-heating rolls
51 heating roll
61 steel roll
65 endless belt heater
66 endless belt
67 heating roll
71 pressing roll sheet
73 film composed of crystalline polymer
81 suction belt unit
82 heating roll
83 suction hole
84 endless belt
85 vacuum box
91 suction heating roll unit
92 suction hole
93 roll
101 outer circumferential cover
102 membrane support
103 microfiltration membrane
104 membrane support
105 core
106a end plate
106b end plate
107 gasket
108 fluid outlet

1. A method for producing a crystalline polymer microporous membrane, comprising:
asymmetrically heating a film composed of crystalline polymer and being fixed, by a heating unit at a temperature equal to or higher than the melting point of a burned product of the crystalline polymer, so that one surface of the film is heated while being in contact with the heating unit, so as to form a semi-burned film having a temperature gradient in a thickness direction of the film composed of crystalline polymer; and
stretching the semi-burned film.

2. The method according to claim 1, wherein the entirety of the one surface of the film composed of crystalline polymer is fixed.

3. The method according to claim 1, wherein at least one surface of the film composed of crystalline polymer is fixed by a member, and the member is at least one of a pressing unit and a suction unit.

4. The method according to claim 3, wherein the pressing unit is any one of a belt, a roll, and a sheet.

5. The method according to claim 4, wherein a pressing pressure applied by the pressing unit is 0.01 MPa to 5 MPa.

6. The method according to claim 3, wherein the suction unit is one of a belt and a roll each having a plurality of holes in a surface thereof and capable of sucking from the surface to the inside thereof.

7. The method according to claim 6, wherein the suction unit is one of a belt and a roll in each of which at least a surface thereof is heatable.

8. The method according to claim 1, wherein the heating unit is one of a belt and a roll in each of which at least a surface thereof is heatable.

9. The method according to claim 1, wherein the crystalline polymer is polytetrafluoroethylene.

10. The method according to claim 1, wherein the stretching is stretching the semi-burned film in a uniaxial direction.

11. The method according to claim 1, wherein the stretching is stretching the semi-burned film in a biaxial direction.

12. The method according to claim 1, further comprising: subjecting the stretched film to a hydrophilication treatment.

13. A crystalline polymer microporous membrane obtained by a method for producing a crystalline polymer microporous membrane,
wherein an average pore size of one surface of the crystalline polymer microporous membrane is greater than the average pore size of the other surface thereof, and continuously varies from the one surface toward the other surface,
wherein the method comprises asymmetrically heating a film composed of crystalline polymer and being fixed, by a heating unit at a temperature equal to or higher than the melting point of a burned product of the crystalline polymer, so that one surface of the film is heated while being in contact with the heating unit, so as to form a semi-burned film having a temperature gradient in a thickness direction of the film composed of crystalline polymer; and stretching the semi-burned film.

14. The crystalline polymer microporous membrane according to claim 13, wherein a value of P1/P2 is 4.5 or higher, provided that a film thickness of the crystalline polymer microporous membrane is represented by X, an average pore size of a portion with a thickness of X/10 in a depth direction from a non-heated surface of the crystalline polymer microporous membrane is represented by P1, and an average pore size of a portion with a thickness of 9X/10 in the depth direction from the non-heated surface is represented by P2.

15. The crystalline polymer microporous membrane according to claim 13, wherein an in-plane variation of the average pore size is produced at a coefficient of variation of 20% or lower.

16. The crystalline polymer microporous membrane according to claim 13, wherein the area of the crystalline polymer microporous membrane is greater than 0.04 m².

17. A filtration filter,
wherein the filtration filter is obtained using a crystalline polymer microporous membrane obtained by a method for producing a crystalline polymer microporous membrane,
wherein an average pore size of one surface of the crystalline polymer microporous membrane is greater than the average pore size of the other surface thereof, and continuously varies from the one surface toward the other surface,
wherein the method comprises asymmetrically heating a film composed of crystalline polymer and being fixed, by a heating unit at a temperature equal to or higher than the melting point of a burned product of the crystalline polymer, so that one surface of the film is heated while being in contact with the heating unit, so as to form a semi-burned film having a temperature gradient in a thickness direction of the film composed of crystalline polymer; and stretching the semi-burned film.

18. The filtration filter according to claim 17, wherein the filtration filter is processed so as to have a pleated shape.

19. The filtration filter according to claim 17, wherein a surface of the crystalline polymer microporous membrane having an average pore size greater than the average pore size of the other surface is used as a filtration surface of the filtration filter.
